(19) United States
(12) Patent Application Publication
(10) Pub. No.: US 2020/0219153 A1
(43) Pub. Date: Jul. 9, 2020

(54) Transaction Model for Bank Balance Sheets

(71) Applicant: ModoPayments, LLC, Richardson, TX (US)

(72) Inventors: Bruce Parker, Richardson, TX (US); Bion Oren, Dallas, TX (US); Aaron Wilkinson, Albany, OR (US)

(73) Assignee: ModoPayments, LLC, Richardson, TX (US)

(21) Appl. No.: 16/735,159

(22) Filed: Jan. 6, 2020

Related U.S. Application Data
(60) Provisional application No. 62/789,300, filed on Jan. 7, 2019.

(51) Int. Cl. G06Q 30/04; G06Q 40/02; G06Q 40/00; G06Q 20/10; G06Q 20/08; G06Q 20/36; G06Q 20/06; G06Q 30/06; H04L 9/06; G06F 9/54

(52) U.S. Cl. CPC G06Q 30/04; G06Q 40/025; G06Q 40/12; G06Q 20/108; G06Q 20/0855; G06Q 20/3678; H04L 2209/38; G06Q 30/0635; H04L 9/0637; G06F 9/54; G06Q 2220/00; H04L 2209/56; G06Q 20/065

(57) ABSTRACT

A system and method are described for provisioning credit availability, including the creation and translation of protocols and instructions for the transfer of funds between financial entities and databases with the use of ERP data. Furthermore, ERP data can be used to calculate gross margin data that can be used for the extension of credit lines.

### CROSS REFERENCE TO RELATED INFORMATION

This application claims the benefit of U.S. Provisional Patent Application No. 62/789,300, filed Jan. 7, 2019, titled “Transaction Model for Bank Balance Sheets”, the contents of which are hereby incorporated herein in its entirety.

### TECHNICAL FIELD

The present disclosure is directed to systems and methods for reconciliation and conversion between disparate payment technologies.

### BACKGROUND OF THE INVENTION

Small and medium sized enterprises face unique challenges in the business world. Large enterprises are able to negotiate beneficial sales and purchases such that typical DPO (days payable outstanding) is typically larger than DSO (days sales outstanding). However, small and medium enterprises have less negotiating power and often end up in the reverse situation, where DSO is greater than DPO (i.e. sales income from buyers is coming in slower than payments have to be made to suppliers). Even with good credit, small enterprises can have trouble bridging the gap between their sales and payments. One problem is that disparate technological systems are used for payments from buyers and payments to suppliers.

### BRIEF SUMMARY OF THE INVENTION

One possible embodiment under the current disclosure can comprise a system for provisioning credit availability to a client of a bank. The system can comprise a client ERP (enterprise resource planning) system interface operable to receive and store the client's customer activity, including customer purchase orders and customer invoices and the client's supplier activity, including supplier invoices. It can further comprise a payment instruction engine operable to monitor the client ERP system and to monitor and communicate with a bank account and a credit account of the client at the bank, the payment instruction engine further operable to initiate payments from a client payment account at the bank to the client's supplier based on supplier invoices independent of the client. The system can also comprise a reconciliation engine using COINs to track and reconcile payments to the supplier and payments from the customer; and a credit availability engine operable to determine a credit line for the client, the credit availability engine determining the credit line by calculating a gross margin for the client based in part on the customer activity and supplier activity from the client ERP system; wherein the payment instruction engine is further operable initiate payment instructions from the client payment account to the bank for loan payments independent of the client.

Another possible embodiment under the present disclosure can comprise an electronic payments translator. The electronic payments translator can comprise a first interface operable to communicate with an ERP system of a client, wherein the ERP system is operable to store invoice, purchase order, and payment information related to the client and to a plurality of customers and to a plurality of suppliers of the client. It can further comprise a second interface operable to communicate with a bank of the client, the second interface operable to communicate with a bank account of the client and to direct funds into or out of the bank account, and further operable to communicate with a credit account of the client and to direct funds into or out of the credit account; and a third interface operable to communicate with a plurality of banks related to the plurality of customers and the plurality of suppliers. Furthermore, the electronic payments translator can be operable to calculate due dates of invoices, purchase orders, and the credit account, and further operable to create payment instructions for use by the bank account, credit account, and plurality of banks to transfer funds before the due dates independent of any action of the client.

Another possible embodiment under the present can comprise a method of transferring funds between a plurality of financial accounts. The method can comprise: receiving, at a server, invoice, purchase order, and payment information related to a company; receiving, at a server, bank account information related to the company, customers of the company, and suppliers of the company; calculating, by a server, a gross margin utilizing the invoice and purchase order information; creating, by a server, first payment instructions for the transfer of funds from a customer to the company; creating, by a server, second payment instructions for the transfer of funds from the company to the supplier; transmitting, by a server, the gross margin to the bank of the company; and determining a credit availability of the company.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of a prior art system for consumer credit.

FIG. 2 is a diagram of a system embodiment under the present disclosure.

FIG. 3 is a flow-chart diagram of an embodiment under the present disclosure.

FIG. 4 is a flow-chart diagram of an embodiment under the present disclosure.

FIG. 5 is a diagram of a system embodiment under the present disclosure.

FIG. 6 is a diagram of a system embodiment under the present disclosure.

FIG. 7 is a method embodiment under the present disclosure.

FIG. 8 is a method embodiment under the present disclosure.

FIG. 9 is a method embodiment under the present disclosure.

FIG. 10 is a table.

FIG. 11 is a table.

FIG. 12 is a diagram of a system embodiment under the present disclosure.

### DETAILED DESCRIPTION OF THE INVENTION

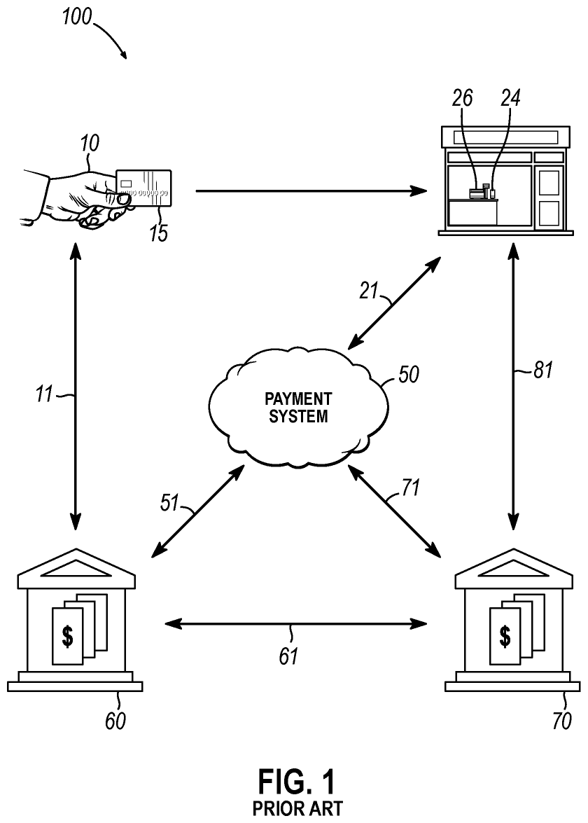

Referring now to FIG. 1, a typical commercial transaction system is shown wherein a consumer 10 uses a credit card 15 to pay at a store 20. Store 20 comprises a register 26 with payment terminal 24 that can communicate with payment system 50. Payment system 50 can comprise a credit card system, such as VISA™ or Discover™. Payment system 50 can communicate with consumer bank 60 and store bank 70. In some situations, these banks 60, 70 may comprise different accounts at the same bank. When a consumer 10 tries to pay with credit card 15, the payment terminal 24 communicates with payment system 50, which in turn communicates with consumer bank 60, to determine whether the subject payment should be approved. In some embodiments consumer bank 60 can comprise a financial institution or account affiliated or comprising a portion of payment system 50. Such communications may involve a payment amount, user information, a credit limit, an approval, or other info. FIG. 1 shows what's commonly called the five-party model of credit card payments. Communications 11 between the consumer 10 and the consumer bank 60 can comprise the consumer's registration and application for a credit card 15 and credit line. Communications 21 between the terminal 24 and payment system 50 can comprise requests for approval for a purchase and approvals or denials, or other information. Communications 51 between payment system 50 and consumer bank 60 can comprise messaging and requests for approval related to a purchase, including approvals or denials. Communications 71 between store bank 70 and payment system 50 can include messaging regarding a purchase price, fund source(s), and other information. Communications 81 between a store 20 and store bank 70 can include registration information for the store's bank account, or other information. Communications 61 between consumer bank 60 and store bank 70 can include the transfer of funds for a purchase, or other communications.

Companies can face more complicated funding or lending challenges than individual consumers. An individual's credit line can initially be calculated based on annual income or other data. As times goes on, based on repayment history, a bank or credit card entity can raise an individual's credit line as necessary. Furthermore, a credit card company always has the checkpoint of the purchase approval process. The company can always reject a purchase at the point of sale if it is too expensive or if certain data (location, amount) make the purchase look suspicious. There are business credit cards. But businesses often need lines of credit on an ongoing basis that don't have the checkpoints inherent in the credit card model. For example, a company may not be able to suffer a declined purchase because its ongoing business can't suffer delays the way an individual consumer can. Whereas a consumer is merely inconvenienced by a declined purchase of a TV or a dinner, a company may be seriously hampered by a single purchase of supplies being declined.

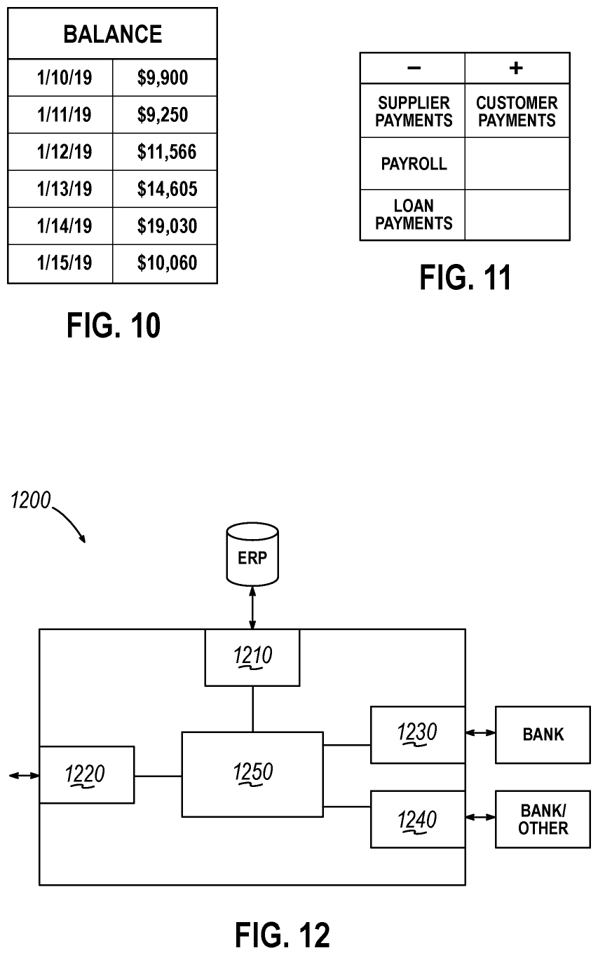

One cause of the credit or funding problem for companies is the use of various systems that use conflicting technologies and accounting systems and methods. One system used by a company will likely be its bank. A bank could be a funding or credit source. But a bank typically only sees daily balance data. The bank may not have visibility or technological capability to see other data, such as loan balance or payments to other institutions, or accounts at other institutions. For example, the table in FIG. 10 shows a hypothetical daily balance for a company. This data is what a bank might typically see, along with each individual transaction and fund recipient or source. The table in FIG. 11 shows data that typically comes into or out of a company. In the debits column are costs such as payments to suppliers, payroll, and loan payments. In the credits column are customer payments. There may be other credits or debits examples not shown as this table is not exhaustive. All of the data shown in FIG. 11 is typically saved in a company's ERP (enterprise resource planning) system. Taking just supplier payments and customer payments, a company's gross margin can be calculated. Gross margin is typically shown as a percentage. For instance, for each unit of goods sold, supplier payments (costs) might be $10,000 and customer payments (revenue) might be $15,000. In this situation gross margin is 33% (i.e. (15,000−10,000)/15,000=0.33 or 33%, or revenue minus costs divided by revenue). A company's bank doesn't see gross margin because it just sees a series of credits and debits without knowing the exact meaning of each transaction. It takes an ERP system or another accounting system to calculate and analyze gross margin.

Gross margin can be a valuable data point when evaluating a company's credit risk. But due to incompatible technologies amongst banks, ERP systems, and other players, calculating gross margin on a real time basis to obtain credit lines, is difficult. One benefit of embodiments under the current disclosure is to allow for greater availability of financial data about a company. This can allow for quicker transfer of data amongst banks, lenders, and ERP systems. This will also allow for greater access to credit lines and other forms of funding. In one example of the use of gross margin, a company could have the daily balance of FIG. 10 with a bank. With a typical daily balance around $10 k-15 k, this company may only be able to borrow $20 k-$200 k from the bank, in one example. Other banks may lend more, some less. With a daily balance around $10 k-15 k, this may be a reasonable risk. However, it may be that the company has gross margins of 60%, which for example could be $120,000 per month. This gross margin data could make the company a good credit risk for larger lines of credit, possibly into the millions.

The gross margin data may be easy to calculate within an ERP system but this data may not be available to third parties like banks due to technological problems. ERP systems tend to be mature and fixed, forming a data silo that's difficult to integrate with other enterprise systems. Software as a Service (SaaS) platforms tend to have a different underlying structure and programming language then ERP systems, for example. Such architectural differences pose difficult integration problems. It can also be hard to identify the correct ERP database. There may be thousands of ERP databases, and most of the tables have hundreds or thousands of flags, fields and values. Extracting the correct data is difficult. Data mapping solutions can be difficult to implement because third party systems, such as banks or SAP or others, might have software updates or other changes that necessitate updates to the integration. To keep up with changes to third party systems the integration system might be constantly undergoing changes just to keep pace. In addition, ERP systems tend to be built to track data for inventory, sales orders, or retail needs. This makes integration into a lending or credit solution more complicated. ERP systems do typically have a library of APIs (application programming interfaces) by which to interact with certain other systems. But often these other systems have their own APIs. There is often a need for translation or integration between APIs of ERP systems and APIs of banks or other financial or credit institutions.

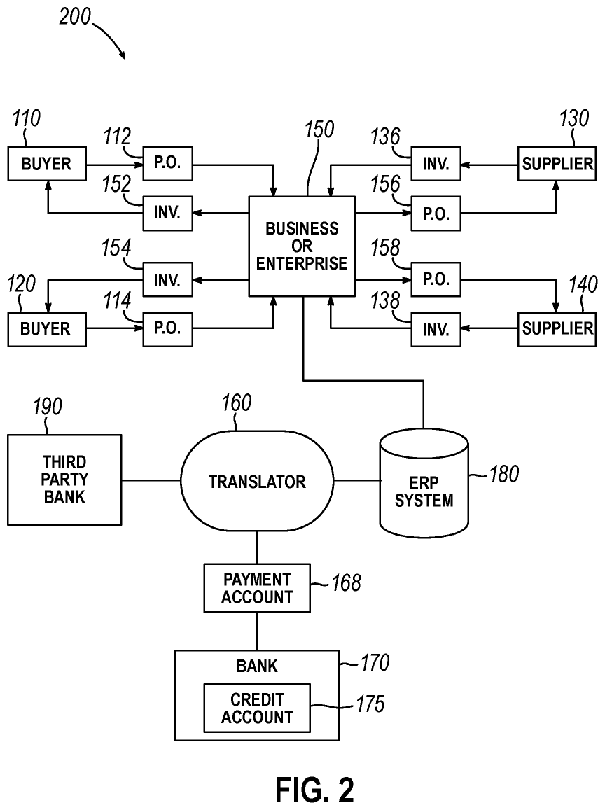

One embodiment of the current disclosure is shown in system 200 in FIG. 2. Business or enterprise 150 has a plurality of buyers 110, 120 and uses a plurality of suppliers 130, 140 for inputs. Business 150 can be a manufacturer, services provider or other business. Enterprise 150 can issue purchase orders 156, 158 to its suppliers who provide invoices 136, 138. Enterprise 150 can also issue invoices 152, 154 to its buyers 110, 120 who issue purchase orders 112, 114. Associated with company 150 is an ERP system 180 that might track inventory, sales, payments, incoming and outgoing invoices, or other data (such as the data in FIG. 11). ERP system 180 can be located at company 150 or elsewhere, such as in the cloud. ERP system 180 can interact with various enterprise functions, including billing and invoicing. The ERP 180 may store data in databases and/or tables or other appropriate formats. Provisioning engine or translator 160 can sit between the ERP 180 and bank 170. Translator 160 can track ERP data, such as gross margin (using supplier and customer payments, or other data) and provide this information to the bank 170. Bank 170 can comprise a commercial bank or other lender or financial institution. Payment account 168 represents the company's funds in a given account at bank 170, such as a checking account. Payment account 168 can keep track of daily balance, among other data. Credit account 175 represents a credit or loan account extended to company 150 by bank 170. Credit account 175 can comprise a loan amount and/or the criteria by which bank 170 might judge the creditworthiness of company 150. Translator 160 can comprise a portion of bank 170, such as a division or account, or can be associated with a third-party financial services company or other service provider. FIG. 2 shows one bank for company 150. However, a company may have accounts or credit lines with a plurality of banks. Embodiments under the present disclosure can include interactions with multiple such banks and can facilitate transfers of funds amongst any number of such institutions.

If enterprise 150 is a small to medium enterprise then its invoices 152, 154 may be paid slower than it has to pay invoices 136, 148. Larger enterprises may face this situation occasionally as well. If enterprise 150 has to pay its invoices 136, 148 more quickly than it receives payment on invoices 152, 154 then it may face a funding gap and may seek some type of credit line to cover that gap. Current financial institutions and systems have trouble extending credits to enterprise 150 in part due to differing invoicing systems or protocols with buyers 110, 120 and with suppliers 130, 140. A financial institution with knowledge of FIG. 10 daily balance data will tend to view the company as a bad credit risk when loaning large amounts. However, this same company may earn a large gross margin despite having a low or modest daily balance. The gross margin data can be calculated with data from the ERP. But banks or other lenders don't typically have access to a company's ERP. These disparate systems are hard to reconcile in a way that makes a credit line calculable.

To take one possible example of a funding gap for an enterprise 150, consider the following scenario. Buyers 110, 120 each buy $24 million in product from enterprise 150 per year. Enterprise 150 can have costs of $16 million per year (personnel, physical plant, inputs, etc). In this scenario, enterprise 150 is paying out $1.25 million per month in costs ($16 M/12 months) and receiving $4 million in income ($48 M/12 months). If invoices 152, 156 are getting paid more slowly than invoices 136, 148 are coming due, then enterprise 150 may have a monthly credit need in the hundreds of thousands or millions of dollars.

Provisioning engine or translator 160 of FIG. 2 can serve several functions. One function can be the translation of communications between APIs of the ERP system 180 and the APIs of any accounts 168, 175 or other functions within bank 170. Translator 160 can interact with ERP 180, and monitor purchase orders 112, 114, 156, 158, and invoices 136, 148, 152, 154, and any amounts paid. Translator 160 can also communicate with payment funds 168 and enterprise account 175 within bank 170 that controls enterprise 150's actual funds and/or credit line. Translator 160 may also direct payments and collection of funds. For instance, while ERP system 180 tracks invoices or payments, it does not direct the flow of funds. Translator 160 can monitor (or copy and store, as desired) the financial data stored in ERP system 180. As purchase orders are issued or invoices received, translator can communicate with bank 170 or payment account 168 to direct the flow of funds. For example, translator 160 may command account 168, via an API or other communication, to initiate a transfer of funds to an account of supplier 130 at third-party bank 190. Translator 160 may also be able to communicate with third-party bank 190 (via API or other communication) to complete or begin the transfer. Such a transfer of funds may flow directly from bank 170 to third-party bank 190, but at the command of translator 160. Alternatively, translator 160 can receive funds and transfer them. Translator 160 may also direct the receipt of funds at payment account 168. For instance, third-party bank 190 may have an account for a buyer 110, 120. Translator 160 may track the issue of invoices and purchase orders with buyers 110, 120 and may communicate with buyers 110, 120 or third-party bank 190 for the issuance of funds to pay the invoices 152, 154 of company 150. Translator 160 can communicate, such as via API, with a plurality of banks 170, 190 or other financial institutions to arrange, command, initiate or finalize any transfer of funds.

Translator 160 can also control or assist in the obtaining of a credit line or credit account 175 from bank 170. Translator 160 can provide gross margin data to bank 170 when or if daily balance data is insufficient for the amount of credit desired by company 150. As described above, gross margin can be calculated using customer payments and supplier payments, sometimes displayed as a percentage. Providing a translation between ERP system 180 and bank 170 may allow bank 170 to view gross margin data and may give company 150 greater access to credit. If credit is issued, such as via credit account 175, translator 160 can direct or initiate the flow of credit funds. Such funds may be deposited in payment account 168 or may be directly dispersed or transferred to other parties, such as suppliers 130, 140. Suppliers 130, 140 may have accounts in bank 190 where funds are deposited. Translator 160 may then direct the repayment of such credit. For example, company 150 may have a monthly payment, or lump sum payment at a later time. Translator 160 and/or ERP system 180 may track due dates for loan payments and account information for repayment. Translator 160 may direct the payment of funds from payment account 168, or from an account at another institution (maybe company 150 has an additional account at third-party bank 190) to credit account 175. Translator 160 may communicate with APIs for banks 170, 190, payment account 168, and/or credit account 175.

An embodiment of provisioning engine or translator 160 can be seen in FIG. 12. Provisioning engine 1200 can comprise client ERP interface 1210; payment instruction engine 1230, credit availability engine 1240, reconciliation engine 1250, and communication interface 1220. Client ERP interface 1210 can be operable to receive and store the client's customer activity, including customer purchase orders and customer invoices and the client's supplier activity, including supplier invoices. Client ERP interface 1210 can communicate via API with a client's ERP system, communicate via other means, or alternatively comprise a portion of the client's ERP system. Payment instruction engine 1230 can be operable to monitor the client ERP system and to monitor and communicate with a bank account and a credit account of the client at the bank. Payment instruction engine 1230 can be further operable to initiate payments from a client payment account at the bank to the client's supplier based on supplier invoices independent of the client. In some embodiments payment instruction engine 1230 can communicate with a plurality of banks of the client, or of suppliers and customers. Reconciliation engine 1250 can use COINs (described further below) to track and reconcile payments to the supplier and payments from the customer. Payment instruction engine 1230 can be further operable to initiate payment instructions from the client payment account to the bank for loan payments independent of the client. Payment instruction engine 1230 can also be operable to monitor all of the client's incoming or outgoing payments and to send payment instructions to all concerned parties, including the client's bank, banks of suppliers or customers, and others. This can include the payment of loans and credit lines from the client's bank account. Credit availability engine 1240 can be operable to determine a credit line for the client, the credit availability engine determining the credit line by calculating a gross margin for the client based in part on the customer activity and supplier activity from the client ERP system. Credit availability engine 1240 may be able to communicate with the client's bank or other sources of credit to determine credit lines, requirements, or for other communications. Communication interface 1220 is optional and may be used to communicate with supplier, customers, banks of the foregoing, or other institutions used for creating payment instructions. Provisioning engine 1200 is shown with all components communicating via the reconciliation engine 1250. However, other embodiments may comprise direct communication between the various components.

The transfer of funds between various parties or accounts, such as company 150, banks 170, 190, buyers 110, 120, suppliers 130, 140, payment account 168, and credit account 175 is not a simple process. Each system involved on behalf of each party may have different coding languages, APIs, accounting practices, and more complexities. One function of translator 160 can be to arrange for the communications and transfers of funds between the parties involved in a given transaction. A payment involves at least two, and sometimes more participants (once you factor in the various kinds of payments systems that exchange data in the middle of the endpoints). Payments participants conduct business with each other via the exchange of payment event data and then by the movement of money. Payment event data is unique from most other kinds of data. These unique qualities include: (a) special requirements for security; (b) being used within financial systems as the basis for accounting; (c) being embedded within the most important businesses processes of every business; and (d) never being owned or managed just by a single party. Payment systems are optimized to process payment requests within their own systems efficiently and then engage outside systems using multiple formats of payment event data to actually move the money (or assets) after the fact. But the exchange between those systems run into inefficiency (friction) due to the different handling of payment event data between those systems. Over the last fifty years, banks and processors have invested significant amounts of money in addressing the core function of money movement and not as much the inefficiency related to payment data loss in that exchange. Now the payments industry has seen an explosion of new entrants in the industry creating significant numbers of new payment event data formats and thereby increasing the industry problem. It is therefore difficult to engage new, different, and varied payments systems globally, even when it makes business sense to do so. It can be difficult to securely conduct payments with parties that a company or individual doesn't know very well, particularly in new digital channels. It can be difficult to reconcile a payment back in context of a purchase, business relationship, or other commercial activity leading to duplicate efforts and resources. In addition, existing payments systems and associated payments networks are difficult to change. Connecting new digital payments experiences to existing payments systems is highly complex both technically and operationally, and very challenging to perform securely, particularly while abiding by applicable compliance rules and regulations and avoiding fraudulent behavior. Furthermore, many new digital payments experiences require new patterns of payments transactions that function in novel ways and exacerbate this challenge, which include aggregate transactions, multi-party transactions, multi-network transactions, just-in-time funding or delivery, split funding and split tender transactions.

The present disclosure includes embodiments for a platform, referred to as a COIN payment event data hub (“COIN hub”), to securely facilitate these connections between payments systems, and new digital experiences. The translator 160 of FIG. 2 can comprise such a COIN hub. As used herein, a COIN is a unique or nearly unique identifier that is used to associate together a series of operations into a complete transaction. A COIN can serve as a transaction ledger, translation hub, transaction server, and other functionality. The COIN represents the COIN accounts, connectors, financial transactions, and status of a financial transfer from a set of sources to a set of destinations. A “COIN account” can refer to an individual representation of an account of one party to a payment event within the context of a COIN that can represent the entire transaction. A single COIN can comprise multiple COIN accounts because a financial transaction involves multiple parties. The COIN may be specific to a set of participants using a payment system associated with the COIN. The COIN may also be specific to a certain time and/or location, for example the COIN may only be valid for the 30 minutes after an indication that a transfer is desired. The COIN may be flexible based upon rules and event driven designs that may be configured to support multiple use cases. Further the COIN may contractually bind together one or more participants, such as company 150, banks 170, 190, buyers 110, 120, suppliers 130, 140, payment account 168, and credit account 175. A COIN account (out of multiple possible COIN accounts on a single COIN) models a real-world financial account or proxy for an account (such as a credit card). Usually the COIN account only models a subset of the account (the account as it participates in a transaction) as opposed to the full value of and all activity on an account.

One purpose of the COIN hub is to enable bi-directional connections to existing payments systems using native semantics via their existing external interfaces, such as APIs. The COIN hub can deliver a composite or “meta” payments transaction management service powered by the COIN transaction. The COIN hub can create a COIN, which can comprise a defined workflow of payments instructions and associated accounting and validation rules which facilitates the movement of value between arbitrary sources and destinations which have been connected to the hub, or system. These COIN money movement transactions can be stimulated by requests to a restful API in order to allow developers of digital payments experiences to control the initiation of money movement, receive updates as to the status, and request any associated resolution of, money movement transactions between arbitrary sources and destinations. The COIN hub can securely store the information associated with money movement in an internal cryptographically secured storage facility.

A COIN can track a given financial transaction and all the related transfers required to make such a transaction happen. One example could be a payment from company 150 to supplier 130, with or without the use of credit account 175 in bank 170. The COIN can also confirm that the funds at issue in a transaction: 1) can be transferred (from a compliance standpoint); 2) can be transferred (from an available funds standpoint); 3) has been requested to be transferred; 4) has actually been transferred; and 5) hasn't been disputed/refunded/etc.

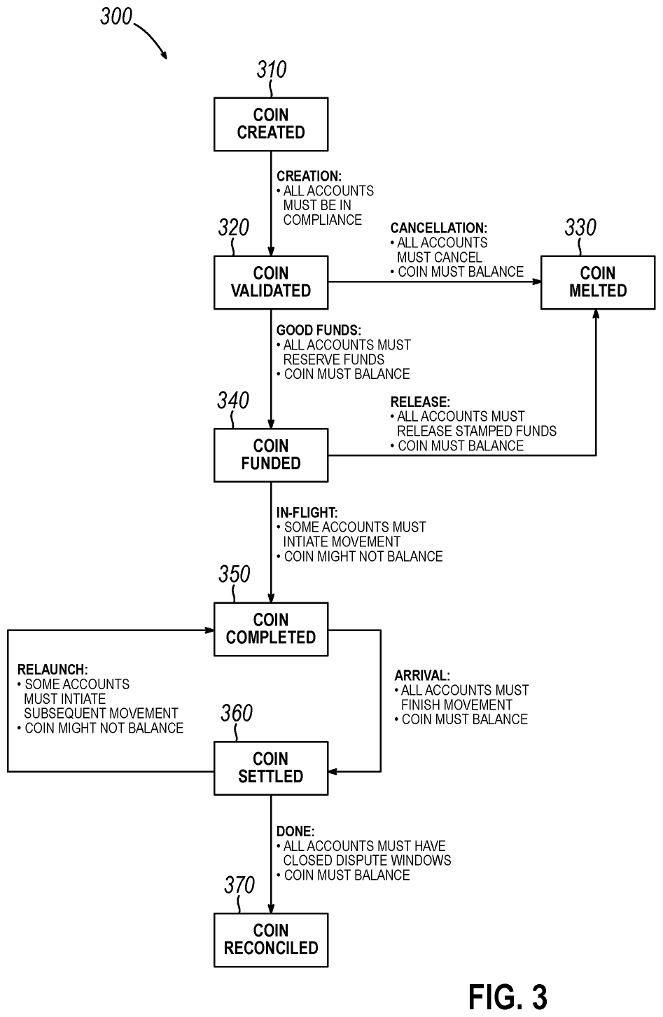

One embodiment of a COIN under the current disclosure can track a financial transaction via a state model. FIG. 3 displays a possible embodiment of a COIN state model, shown as a flow chart 300. Beginning at 310, a COIN can be created and at such creation all related accounts should be in compliance. When these steps are taken the COIN will have been validated 320. When the related accounts have reserved funds and the COIN is balanced, then the COIN may be funded 340. From pressing, a COIN may pass to either melting 330 or funding 340. A COIN can be melted at 330 when a transaction or account is canceled. To be melted all accounts must cancel and the COIN should balance. From stamping 340, a COIN may pass onto completed 350. At 350, some related accounts should initiate movement, such as a transfer of funds, and a completed COIN may not balance from an accounting perspective. If melted after funding, the related accounts that initiated movement of funds should have their funds released from receiving parties and the COIN must balance. If the COIN is completed 350, then the system may wait for movement on all funds to finish and for the COIN to balance. Once movement is complete and the COIN is balanced, then the COIN can be settled 360. After being settled 360, it may be that further movement of funds is needed and the COIN is relaunched to be completed again at 350. Subsequent movement may be needed for various reasons, some transfer of funds may have been dependent on a previous transfer, or a re-completion may vary the amounts due by each account. From settled 360, the COIN may also proceed to being reconciled 370. At 370, all the related accounts should have closed dispute windows and the COIN must balance. Another shorthand way of describing each state is as follows. Validated 320 means that COIN participants are verified (e.g. terms agreed to, etc.). Funded 340 means that funds have been reserved or shown to be good funds (e.g. balance check, hold placed, etc.). Completed 350 means that fund movement has initiated (e.g. authorization has been captured, wire sent, etc.). Settled 360 means that fund movement has finished (e.g. settlement, etc.). Reconciled 370 means that fund movement is finalized (e.g. dispute window closed, etc.). Melted 330 means that fund movement is canceled (e.g. authorization canceled, etc.). This state model can provide the means of normalizing the tracking of the COIN's view of the COIN accounts so that the COIN is able to treat each external transaction system in a consistent way with the details on differences handled by the COIN account implementations. The implementation of validated, funded, completed, settled, reconciled, and melted states can allow the methods and systems that are being disclosed to work correctly with disparate financial systems that behave differently in accomplishing exchange of value or currency.

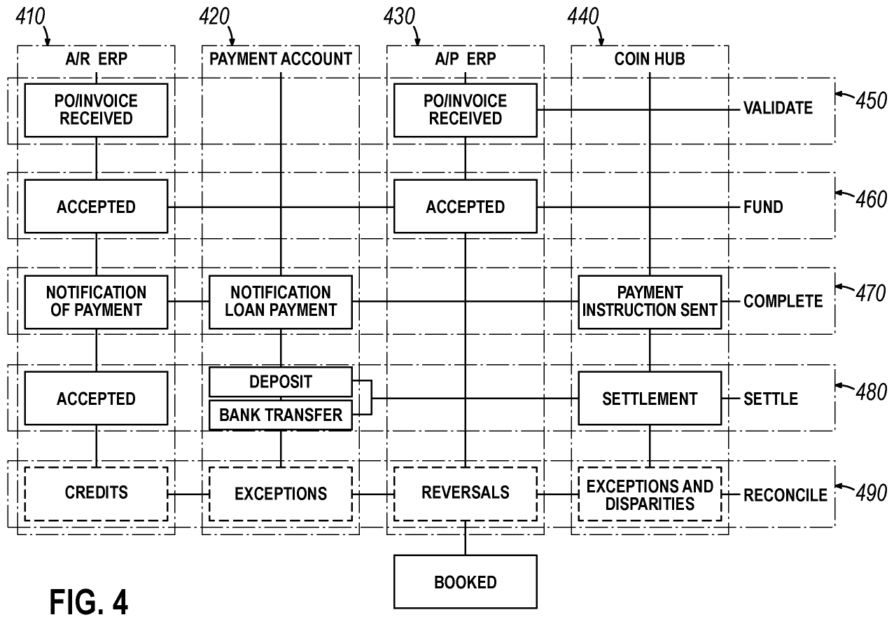

The state model of FIG. 3 can be applied to a possible transaction between the parties of FIG. 2. FIG. 4 displays an embodiment of the COIN states and transaction flow of a possible transaction. The top of FIG. 4 shows columns 410-440 for four different accounts or entities involved in payments made or received by company 150 of FIG. 2. The first column 410 represents an accounts receivable portion of the ERP system 180. Column 420 represents the payment account 168. Column 430 represents the accounts payable portion of ERP system 180. And column 440 represents the COIN hub, preferably located within translator 160. The COIN hub can comprise software and/or hardware for carrying out the COIN states described herein. The rows 450-490 represent states of a COIN: validate 450, fund 460, complete 470, settle 480, and reconcile 490. A hypothetical transaction is depicted in FIG. 4. At the validate 450 stage, purchase orders and invoices are received by the parties, company 150, a supplier 130 and a buyer 110. At the fund 460 stage, the invoiced cost is accepted by the parties. At the complete 470 stage, notification of payment is sent by the buyer in column 410, and by the payment account in column 420. Payment instructions are sent by the COIN hub in column 440. The payment instructions are received by any party making a payment and allow for the transfer of funds. The instructions can comprise detail code or protocols for one account to send funds to another. At the settle 480 stage, a deposit is received by the bank 170 in the credit account 175 from the payment account 168. This deposit is to pay off a loan. In addition, a transfer of funds from the bank 190 of the buyer 110 is sent to account 168 of company 150. At this stage the COIN hub settles the transactions. At the reconcile 490 stage, credits, exceptions, reversals, or disparities can be performed or accounted for. These actions may not be needed if there is no problem with the transaction. Once reconciliation has been completed, if necessary, the transaction can then be booked.

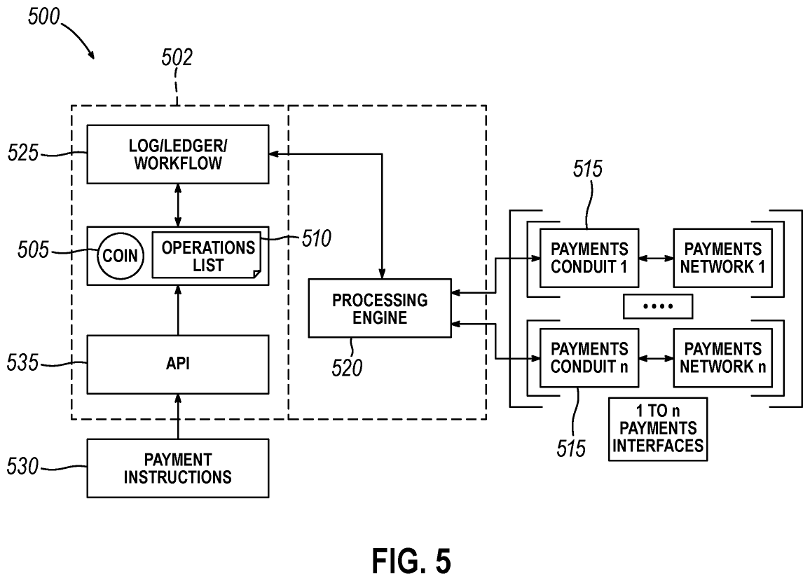

One embodiment of a COIN hub can be seen in FIG. 5. FIG. 5 shows one embodiment of a block diagram of COIN based payment operations 500. Log 525, COIN 505, operations list 510, and API 535 can together comprise COIN hub 502, which can also comprise processing engine 520. Processing engine 520 and API 535 may not comprise the COIN hub in certain embodiments. COIN hub 502 preferably resides at provisioning engine or translator 160 of FIG. 1, but could reside elsewhere in certain embodiments. A preferred embodiment of COIN hub 502 can comprise the reconciliation engine 1250 of FIG. 12. Other embodiments of COIN hub 502 can comprise additional or fewer components of FIG. 12. When a payment request or instruction 530 is received via API 535, a COIN 505 may be created. An operations list 510 may be created by COIN hub 502, or may have been previously created and is associated with the type of transaction requested. Operations list 510 may comprise one or more payment operations that are required in order to complete the payment requested 530. For example, operations list 510 may comprise the instructions necessary to carry out the transactions set forth in FIG. 4. Each payment operation is associated with a payment conduit 515. There may be 1 to n payment operations each corresponding to a payment conduit 515. For example, a first payment conduit may be related to a transfer from third-party bank 190 to bank 170 of FIG. 1. A second payment conduit may be related to a transfer from bank 170 to third-party bank 190, or a transfer between payment account 168 to credit account 175. Log/ledger/workflow 525 tracks the completion of payment operations in the operations list 510, like the way columns 410-440 track the stages of a COIN. Processing engine 520 may monitor or cause payment operations to execute. At the completion of all the payment operations in the operations list 510, the COIN will be balanced from an accounting standpoint.

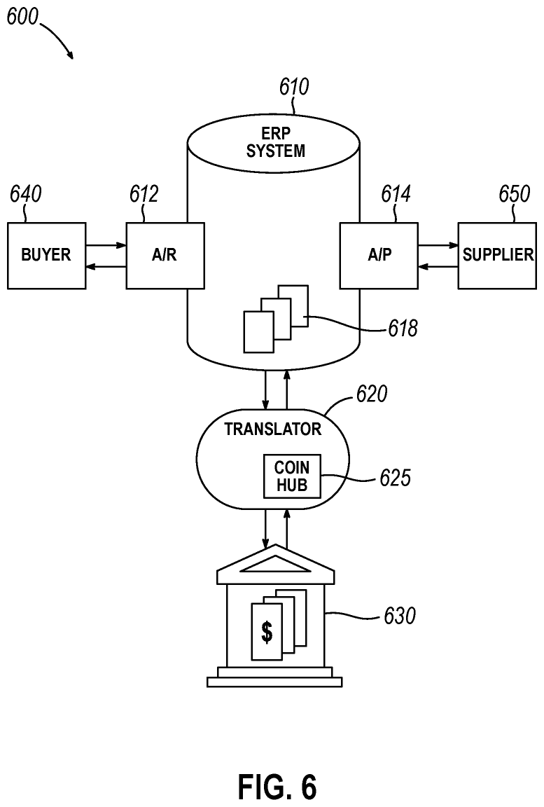

FIG. 6 shows another possible embodiment 600 of ERP system 610 and translator 620 and their interactions. ERP system 610 can comprise an accounts receivable interface 612 and an accounts payable interface 614. These interfaces can receive invoices or purchase orders from buyers 640 or suppliers 650. Interfaces 612, 614 can comprise outward facing interfaces accessible by buyers 640 and suppliers 650 for automated or manual upload of material, or interfaces accessible to company employees for the upload of received invoices and purchase orders. Tables or databases 618 within the ERP store data, such as invoices, purchase orders, payments made or received, dates, sales, and more. Translator 620 communicates with ERP 610 and can access, or store copies of, some or all data stored therein. COIN hub 625 preferably resides in translator 620. Translator 620 can communicate with banks or financial institutions 630, which can include the bank of the company or banks of supplier or buyers. This includes the ability to communicate with payment accounts, credit accounts or other accounts at such banks 630. In the embodiment of FIG. 6, translator 620 has three main responsibilities. First, it gets AR and AP information from the ERP and calculates gross margin. Second, it creates instructions for the payment of accounts payable on behalf of the client company. Such instructions can include any EFT (electronic funds transfer), ACH (automated clearing house), or other system protocols that a bank or financial institution uses. Funds can be transferred in any currency, crypto currency, or other standard of value used in a financial network. Third, it creates instructions to remit gross margin to a deposit or credit account to pay back a loan at one of the banks or financial institutions 630.

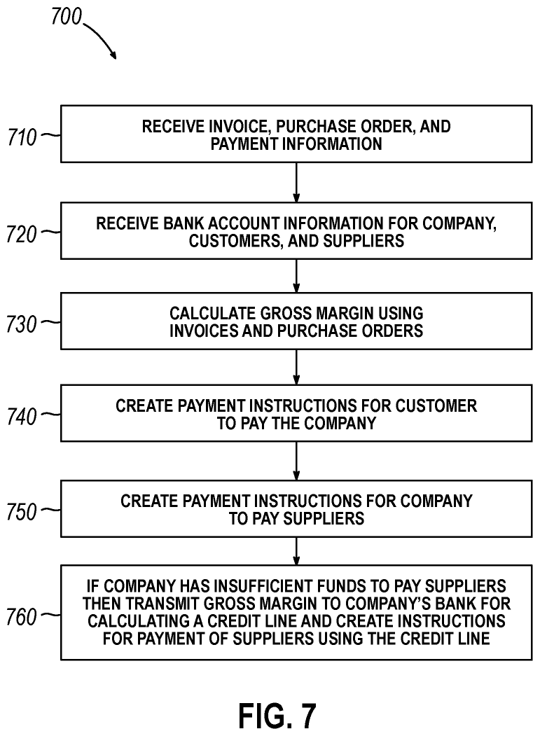

FIG. 7 displays a possible method embodiment 700 for transferring funds under the current disclosure. At step 710, invoice, purchase order, and payment information are received relating to a company. At step 720, bank account information is received for the company and some of its customers and suppliers. At 730 a gross margin is calculated for the company using invoices and purchase orders. At 740, first payment instructions are created for the customer to transfer funds to the company. These instructions can be sent to the customers or the customers' banks, accounts, or fund source. At 750, payment instructions are created for the company to pay its suppliers. These instructions can be sent to the company's bank, account, or fund source. At 760, if the company has insufficient funds to pay its suppliers, then the gross margin can be transmitted to the company's bank for the calculation of a credit line. Instructions can be created for the transfer of funds from the credit line to the supplier(s).

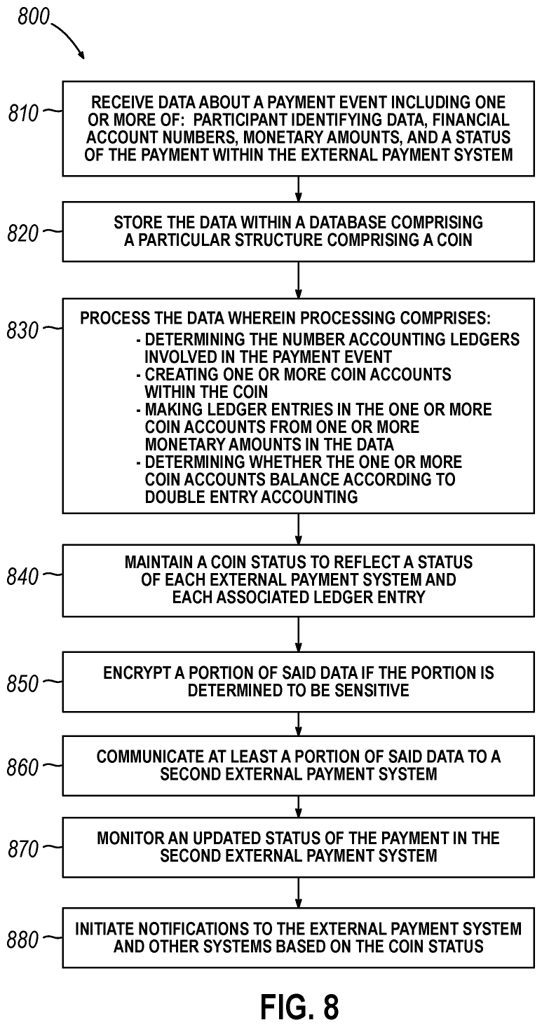

FIG. 8 displays a method embodiment 800 of creating a COIN under the present disclosure. Such a COIN can be used by the translator for creating payment protocols or instructions. At 810, data about a payment event is received from an external payment system, including one or more of; a participant identifying data, one or more financial account numbers, one or more monetary amounts, and a status of the payment within the external payment system. Participant identifying data can include an email address, account number, identification number, or other information. At 820, the data is stored within a database comprising a particular structure comprising a coin. At 830, the data is processed, wherein processing comprises; determining the number of accounting ledgers involved in the payment event; creating one or more coin accounts within the coin; making ledger entries in the one or more coin accounts from one or more monetary amounts in the data; and determining whether the one or more coin accounts in the coin balance using double entry accounting. At 840, a coin status is maintained to reflect a status of each external payment system and each associated ledger entry. At 850, a portion of said data is encrypted if the portion is determined to be sensitive. At 860, at least a subset of data is communicated to a second external payment system. At 870, an updated status of the payment is monitored in the second external payment system. At 880, notifications are initiated to the external payment system and other systems based on the coin status.

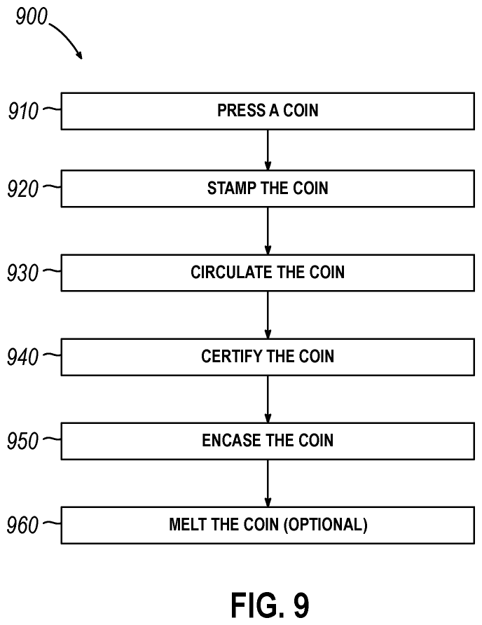

Another method embodiment 900 under the present disclosure is shown in FIG. 9. Method 900 comprises a method for monitoring and updating a status of a COIN, the COIN signifying transactions related to a payment event and associated ledger events. At 910, the coin is pressed (or validated), wherein pressing/validating the coin comprises validating one or more sets of credentials and one or more compliance functions. At 920, the coin is stamped (or funded), wherein stamping/funding the coin comprises authorizing debits and credits associated with the financial transaction. At 930, the coin is circulated (or completed), wherein circulating/completing the coin comprises communicating money movement instructions to the payment service provider, the bank, and the retailer. At 940, the coin is certified (or settled), wherein certifying the coin comprises verifying with a system of record that an amount recorded as circulated is equal to an actually circulated amount. At 950, the coin is encased (or reconciled), wherein encasing/reconciling the coin comprises waiting for a dispute period to end and closing all further money movement once the dispute period has ended. Optionally, at any point during the process, the coin can be melted at 960, wherein melting the coin comprises canceling the coin and stopping all further transactions on the coin.

Further disclosure regarding the COIN can be found in U.S. application Ser. No. 15/697,145, entitled “COIN Operated Digital Payments Hub,” the contents of which are hereby incorporated by reference.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for provisioning credit availability to a client of a bank, the system comprising:
a client ERP (enterprise resource planning) system interface operable to receive and store the client's customer activity, including customer purchase orders and customer invoices and the client's supplier activity, including supplier invoices;
a payment instruction engine operable to monitor the client ERP system and to monitor and communicate with a bank account and a credit account of the client at the bank, the payment instruction engine further operable to initiate payments from a client payment account at the bank to the client's supplier based on supplier invoices independent of the client;
a reconciliation engine using COINs to track and reconcile payments to the supplier and payments from the customer; and
a credit availability engine operable to determine a credit line for the client, the credit availability engine determining the credit line by calculating a gross margin for the client based in part on the customer activity and supplier activity from the client ERP system;
wherein the payment instruction engine is further operable initiate payment instructions from the client payment account to the bank for loan payments independent of the client.

2. The system of claim 1, wherein the payment instruction engine is operable to initiate payments on a blockchain.

3. The system of claim 1 further comprises a communication interface operable to communicate with a bank of a supplier or customer of the client.

4. The system of claim 1, wherein the payment instruction engine is operable to initiate a transfer of crypto currency.

5. The system of claim 1, wherein calculating the gross margin comprises subtracting a first invoice amount from a second invoice amount and dividing the result by the second invoice amount.

6. The system of claim 1, wherein the payment instruction engine is operable to create and second payment instructions to a customer of the client.

7. The system of claim 1, wherein the payment instruction engine is operable monitor and communicate with a second bank account and a second credit account of the client at the second bank.

8. The system of claim 1, wherein the payment instruction engine is operable to communicate via application programming interfaces (APIs) with a plurality of banks.

9. An electronic payments translator comprising:
a first interface operable to communicate with an ERP system of a client, wherein the ERP system is operable to store invoice, purchase order, and payment information related to the client and to a plurality of customers and to a plurality of suppliers of the client;
a second interface operable to communicate with a bank of the client, the second interface operable to communicate with a bank account of the client and to direct funds into or out of the bank account, and further operable to communicate with a credit account of the client and to direct funds into or out of the credit account;
a third interface operable to communicate with a plurality of banks related to the plurality of customers and the plurality of suppliers;
wherein the electronic payments translator is operable to calculate due dates of invoices, purchase orders, and the credit account, and further operable to create payment instructions for use by the bank account, credit account, and plurality of banks to transfer funds before the due dates and independent of any action from the client.

10. The electronic payments translator of claim 9, wherein the electronic payments translator is operable to communicate with the bank account via an API.

11. The electronic payments translator of claim 9, wherein the electronic payments translator is operable to calculate a gross margin based on the invoice and purchase order information and to communicate the gross margin to the bank for use in calculating a limit to the credit account.

12. The electronic payments translator of claim 9, wherein the payment instruction comprise protocol for a transfer of funds from the credit account to one of the plurality of banks.

13. The electronic payments translator of claim 9, wherein the payment instructions comprise protocol for a COIN, wherein at each stage of the protocol the COIN is balanced from an accounting perspective.

14. The electronic payments translator of claim 13, wherein the protocol for the COIN comprises the stages:
validated, wherein the bank account, the credit account or the plurality of banks agree to the protocol;
funded, wherein the bank account, the credit account or the plurality of banks prove to have good funds;
completed, wherein the bank account, the credit account or the plurality of banks begin fund transfers;
settled, wherein the bank account, the credit account or the plurality of banks finished fund transfers; and
reconciled, wherein the bank account, the credit account or the plurality of banks finalize the fund transfers by closing a dispute window.

15. The electronic payments translator of claim 11, wherein gross margin is expressed as a percentage.

16. The electronic payments translator of claim 11, wherein gross margin is expressed as a dollar amount.

17. A method of transferring funds between a plurality of financial accounts, the method comprising;
receiving, at a server, invoice, purchase order, and payment information related to a company;
receiving, at a server, bank account information related to the company, customers of the company, and suppliers of the company;
calculating, by a server, a gross margin utilizing the invoice and purchase order information;
creating, by a server, first payment instructions for the transfer of funds from a customer to the company;
creating, by a server, second payment instructions for the transfer of funds from the company to the supplier;
sending the gross margin information to a bank of the company; and
determining a credit availability for the company.

18. The method of claim 17, wherein the first and second payment instructions comprise the states of validating, funding, completing, settling, and reconciling.

19. The method of claim 17, further comprising creating, by a server, fourth payment instructions for the transfer of funds from the customer to the line of credit.

20. The method of claim 18, wherein at each state the transaction is balanced from an accounting perspective.
